(19) United States
(12) Patent Application Publication
(10) Pub. No.: US 2026/0065049 A1
(43) Pub. Date: Mar. 5, 2026

(54) SYSTEMS AND METHODS FOR BUILDING ARTIFICIAL INTELLIGENCE AGENTS

(71) Applicant: Salesforce, Inc., San Francisco, CA (US)

(72) Inventors: Shafiq Rayhan Joty, San Jose, CA (US); Xuan Phi Nguyen, Singapore (SG); Shrey Pandit, San Francisco, CA (US); Senthil Purushwalkam Shiva Prakash, Palo Alto, CA (US); Austin Xu, San Francisco, CA (US)

(21) Appl. No.: 19/043,190

(22) Filed: Jan. 31, 2025

Related U.S. Application Data
(60) Provisional application No. 63/689,485, filed on Aug. 30, 2024.

(51) Int. Cl. G06N 3/08

(52) U.S. Cl. CPC G06N 3/08

(57) ABSTRACT

Embodiments described herein provide a method for training a neural network based language model (LM). The method includes receiving, via a data interface, a training dataset including pairs of user queries and ground-truth responses; generating, via the LM, a plurality of responses based on a query from the training dataset; identifying, from the plurality of responses, a first response having a first similarity metric value below a threshold, based on a similarity metric associated with a corresponding ground-truth response from the training dataset; training the LM using the first response as a negative sample and a second response as a positive sample such that the LM after training is more likely to generate the positive sample and less likely to generate the negative sample; receiving, via a user interface, a query; and generating a response to the query via the trained LM.

### CROSS REFERENCE(S)

The instant application is a nonprovisional of and claim priority under 35 U.S.C. 119 to U.S. provisional application No. 63/689,485, filed Aug. 30, 2024, which is hereby expressly incorporated by reference herein in its entirety.

### TECHNICAL FIELD

The embodiments relate generally to machine learning systems for artificial intelligence (AI) agents, and more specifically to systems and methods for training AI agents.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Training of such an LLM-based AI agent may be performed using known-good conversations between a user and an agent. Retrieval-augmented generation (RAG) may also be used by an LLM to retrieve information relevant to a query which may be added to the context of the LLM, improving response accuracy. LLMs as currently trained, however, perform poorly across different kinds of tasks, and generate incorrect results (e.g., hallucinations) even with RAG.

### BRIEF DESCRIPTION OF THE DRAWINGS

FIG. 1 illustrates an application of an LLM based AI agent, according to embodiments of the present disclosure.

FIG. 2 is an exemplary multi-turn chat training data according to some embodiments.

FIG. 3 is a simplified diagram of a non-coherent distractors training data generation method according to some embodiments.

FIG. 4 is a simplified diagram of a coherent distractors training data generation method according to some embodiments.

FIG. 5A is a simplified diagram of a preference optimization method according to some embodiments.

FIG. 5B is a simplified diagram illustrating a language model training framework according to some embodiments.

FIG. 6A is a simplified diagram illustrating a computing device implementing the language model training framework described in FIGS. 1-5B, according to some embodiments.

FIG. 6B is a simplified diagram illustrating a neural network structure, according to some embodiments.

FIG. 7 is a simplified block diagram of a networked system suitable for implementing the language model training framework described in FIGS. 1-6B and other embodiments described herein.

FIG. 8 is an example logic flow diagram illustrating a method of training a neural network based language model based on the framework shown in FIGS. 1-7, according to some embodiments.

FIGS. 9-12 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

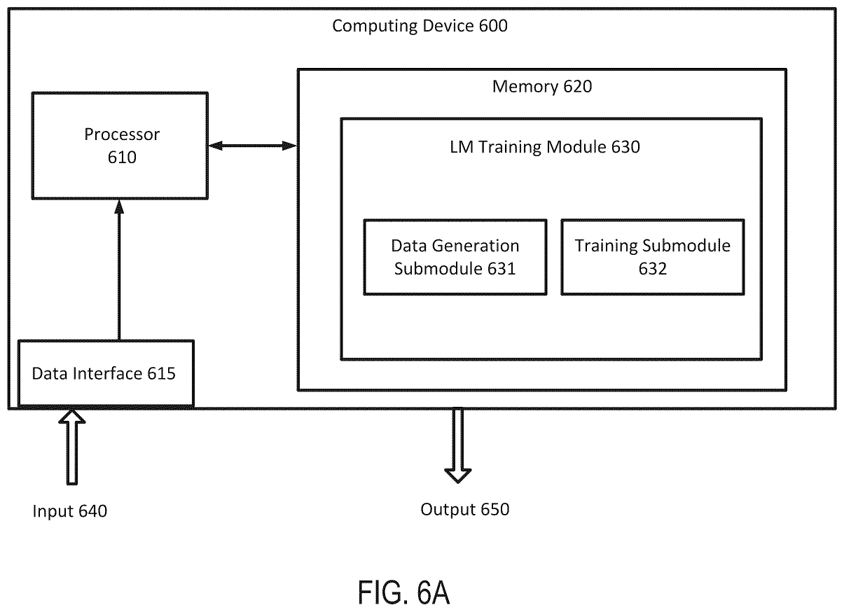

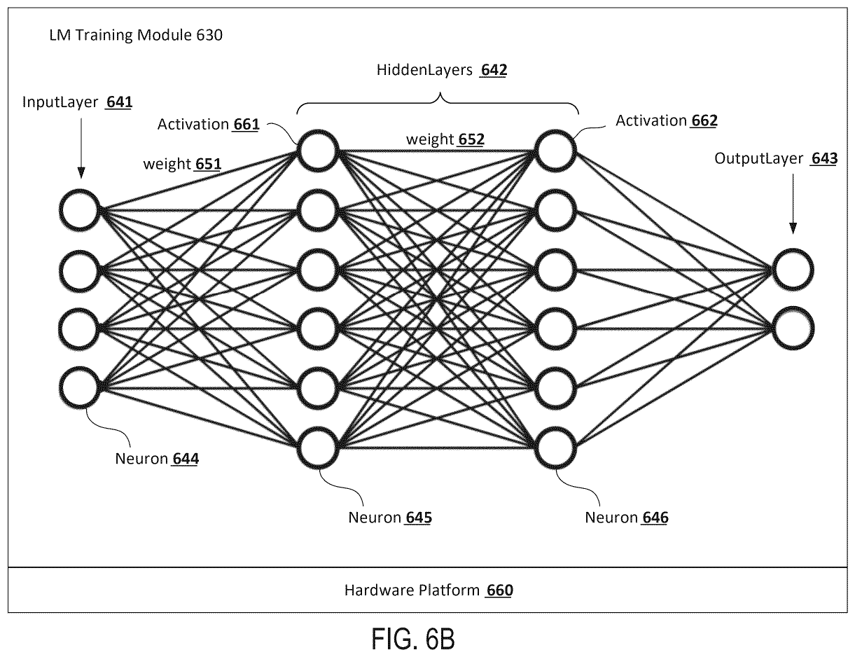

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Training of such an LLM-based AI agent may be performed using known-good conversations between a user and an agent. Retrieval-augmented generation (RAG) may also be used by an LLM to retrieve information relevant to a query which may be added to the context of the LLM, improving response accuracy. LLMs as currently trained, however, perform poorly across different kinds of tasks, and generate incorrect results (e.g., hallucinations) even with RAG.

In view of the need for improved methods for training language models, embodiments described herein provide a training framework for an LLM-based AI agent. The framework includes the generation of synthetic training data for a number of different tasks. In some embodiments, in addition to the system prompt/user/agent turns, training data may include “thought” and “observation” turns intended to invoke multi-turn reasoning of the LLM.

Preference learning of an LLM may be performed for preference learning. Preference learning may be performed using a user query with a positive known-good response and a negative known-bad response. In some embodiments, the LLM itself may generate samples which are verified via a post-processing step. Given a query, the LLM is used to generate a number of responses. Each of those responses is compared to a known-good response. If a particular response is sufficiently close to the known-good response, then that is added to a “chosen” list. If it is not close enough, it is added to a “rejected” list. Items from the chosen list are used as positive samples, and items from the rejected list are used as negative samples. Additional training steps may be performed in addition to direct preferent optimization. For example, a supervised fine-tuning stage may train the model on a number of different tasks represented in the training data.

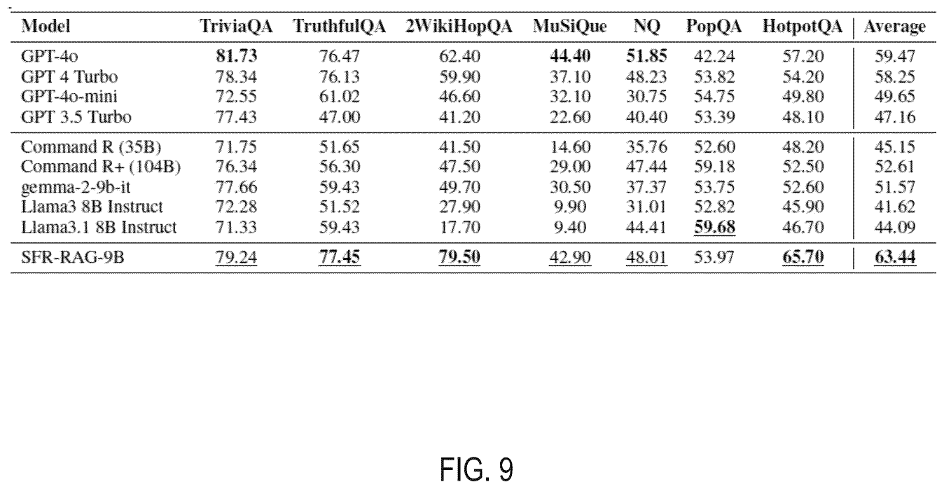

Embodiments described herein provide a number of benefits. For example, the training methods described herein improve the accuracy of LLM responses and reduce hallucinations. By training on a number of different tasks as described herein, the LLM is able to better handle unanswerable, counterfactual, or otherwise low-quality and irrelevant contexts, perform complex multi-hop reasoning, and produce reliable citations. As illustrated in FIGS. 9-13, embodiments herein outperforms existing methods, achieving state-of-the-art results in a number of different scenarios. Embodiments herein also produce a model that is resilient to alteration in the contextual information and behave appropriately when relevant context is removed. Additionally, embodiments herein maintain competitive performance in general instruction-following tasks and function-calling capabilities. The direct preference optimization training method described herein improves training efficiency by not training on queries for which the model reliably produces correct results. Further, by training on data generated by the model itself rather than just on a ground-truth data from a training dataset, the model is more efficiently and accurately trained as it is not forced to reproduce the exact response when wording or other differences are allowable. Therefore, with improved performance on language model training, neural network technology in language model training is improved.

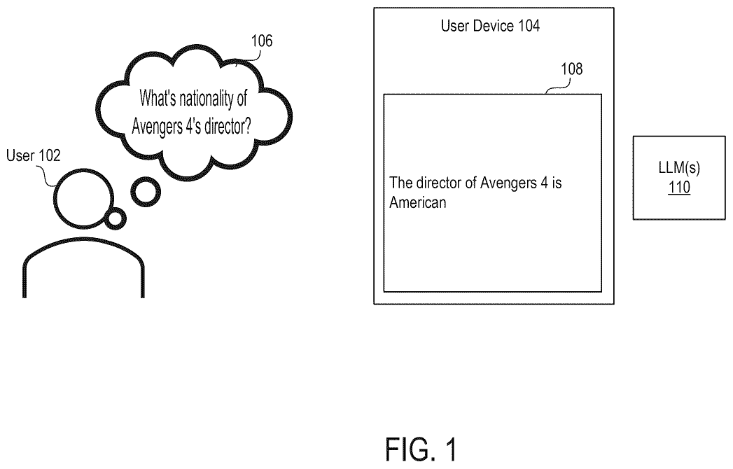

FIG. 1 shows an application 100 of an LLM based AI agent, according to embodiments of the present disclosure. A user 102 may utter a query 106 in natural language. In response, a user device 104 may output/display an answer 108 on a display interface, such as a screen. In some embodiments, answer 108 is the output of an artificial intelligence (AI) agent, which is built on a bot server that is communicatively connected to user device 104. The AI agent may be based on, or include, an LLM. In some embodiments, the LLM receives query 106 through utterance of user 102, which may retrieve a corpus of documents, and generate an output based on the retrieved documents.

As an example, query 106 may include a question of “What is the nationality of Avengers 4's director?” The AI agent may include the query 106 in a predefined format providing instruction to the LLM how to generate a response to query 106, referred to as a “prompt,” which may be fed to an LLM as input. The LLM 110 may in turn provide answer 108, e.g., a summary of the types of medical coverages in a predetermined format, e.g., a bullet-point format, such that one type of medical coverage is listed behind a bullet-point. In some aspects, for example, a citation of document(s) that mentioned the medical coverage is provided behind the respective bullet.

For example, an input prompt may be constructed to include an instruction for the LLM 110 to generate an answer in a particular way and the original query 106. An example prompt may take a form similar to the following: “You are a helpful assistant. You may call an external tool to retrieve knowledge to answer the user questions. Provide reasoned yet succinct answers.”

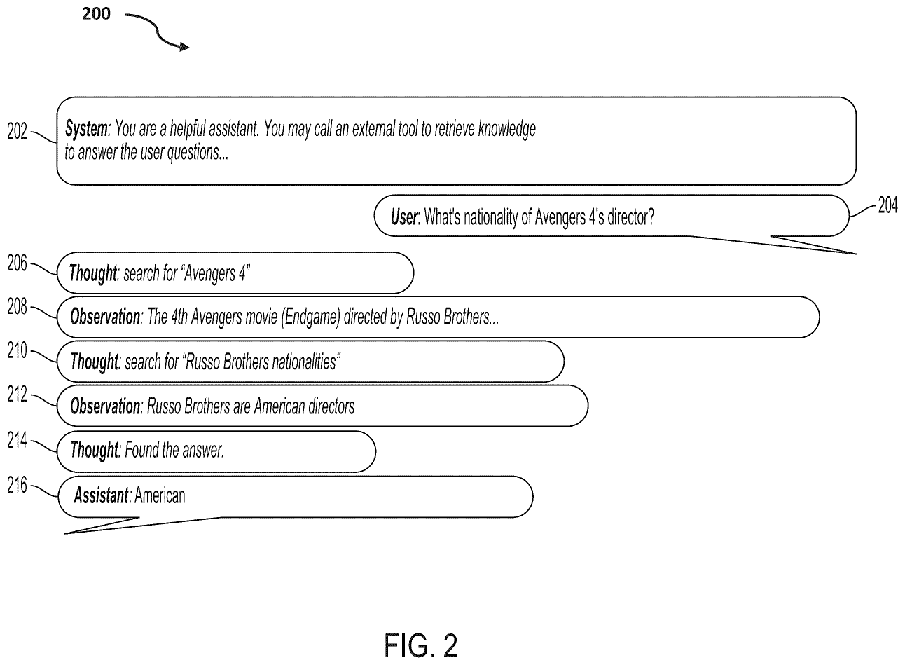

The underlying LLM may be implemented at user device 104, or at a remote server which is accessible by the user device 104. The LLM may be trained with a large corpus of texts and/or documents to provide a user desirable response as further described in FIG. 2 below.

FIG. 2 is an exemplary multi-turn chat training data 200 according to some embodiments. In some embodiments, training data may include chats with multiple turns associated with different roles. As illustrated, roles may a system role, a user role, a thought role, an observation role, and an assistant role. The system role may represent a system prompt describing a desired behavior of the assistant role. In some embodiments, the system role is specified once at the beginning of a chat and is used to define general characteristics of the AI assistant with general instruction on how to respond to user inputs. The user role may represent a human user interacting with the assistant role. The thought role may represent an intermediate generation by the LM not presented to the human user. The observation role may represent retrieved information not presented to the human user. The assistant role may represent a response provided to the human user according to the guidelines given by the system turn.

In the illustrated example a first utterance 202 is a system utterance stating “you are a helpful assistant. You may call an external tool to retrieved knowledge to answer the user questions . . . ” The next utterance 204 is a query from the user stating “What's the nationality of Avengers 4's director?” The next utterance 206 is a thought, stating “search for ‘Avengers 4’” indicating a thought to retrieve information on Avengers 4. The next utterance 208 is an observation representing retrieved information that includes “The 4th Avengers movie (Endgame) directed by Russo Brothers . . . ” The next utterance 210 is thought, stating “search for ‘Russo Brothers nationalities.” The next utterance 212 is an observation representing retrieved information that includes “Russo Brothers are American directors.” The next utterance 214 is thought, stating “Found the answer.” Finally, utterance 216 is from the Assistant role, representing the user-facing response, stating “American.”

By including additional roles (e.g., thought and observation roles) in addition to those which are generally user-visible, this allows for better training of an LLM which is capable of chain-of-thought multi-step responses. For example, in a training dataset that only includes a user query and an assistant response, there is no direct data for training intermediate steps which may be performed by an LLM that are not visible to a user (e.g., “thought” steps and retrieved context information “observation”). As complex applications with (potentially multi-step) retrieval or function calling are being employed, such roles may have to handle increasingly complex and confusing data formats. For example, in retrieval tasks, external context information may be injected into the System or User turn, or may even form a part of the Assistant turn if the context is retrieved following a model's function call. This may cause confusion and distraction from the actual instruction or question queried by the user in the User turn. In other words, there have been no generally agreed-upon position to store the contextual information in such tasks. In another example of agentic function calling tasks, the Assistant turn has to produce responses that use specific tool syntax and expects to receive the function call's results following that. This makes the fine-tuning process tricky as the function's results, which are part of Assistant turn and typically contain answer clues, need to be masked out from the loss to prevent memorization. Furthermore, for certain applications, practitioners may prefer to hide model's reasoning, or intermediate actions invoked by the model from the user and only show user-friendly responses. Having all model generation enclosed within the Assistant turn may hinder such applications and use cases.

To overcome such complexities, embodiments herein provide two more optional roles (turns) in the conversational template, “Thought” and “Observation.” As shown in FIG. 2, the Observation role is designated to house any contextual information acquired from external sources, which can be either retrieved documents for retrieval use case or function call's results in agentic tool use scenario. During training, System, User and Observation turns are not trainable as they are input information for the model to generate responses. Meanwhile, the Thought role is designed for the model to speak out any internal reasoning, or tool use syntax to invoke certain function calls. Depending on real use cases, practitioners may seamlessly hide the Thought from the end user to preserve privacy and security. Similar to Assistant, texts within the Thought turn are to be included in the fine-tuning loss to train the model to produce such “thoughts”.

Training data may be generated such that a variety of different tasks and/or potentially confounding factors may be trained on in order to improve LLM performance in different scenarios. Training data may be used for supervised fine-tuning of an LLM using a base pre-trained model on the various tasks, while also making sure it has the general instruction following capability.

One task for supervised fine tuning training may be contextual tasks. One goal of supervised fine-tuning is to make full use and complete comprehension of any provided contextual information in the real-world RAG scenarios. This trait includes many capabilities, among which are (i) extracting relevant information from arbitrary long contexts, (ii) recognizing the lack of relevant information and abstaining from hallucinated generation, (iii) recognizing potential conflicting information in contextual passages, and (iv) being resilient to distracting information or counterfactual contexts that may be contradicting with pre-trained parametric knowledge. In some embodiments, a system automatically generates instruction tuning data targeted to familiarize the model with such diverse tasks and scenarios. To do so, the system applies multiple diverse and novel strategies to prompt an open-sourced LLM against diverse unlabeled text data to create contextual question-answering based conversations. More formally, the instruction data sample Cᵢ is generated from prompting strategy Fᵢ as:

$${C}_{i} ∼ {F}_{i} ( \cdot \vert {d}_{1} , {d}_{2} , … ; θ ) \qquad ( 1 )$$

where θ is an instruction-tuned LLM, while {d₁, d₂, . . . }∈D is a set of unlabeled documents or chunks strategically retrieved from an existing text corpus D. Each strategy Fᵢ focuses on a specific RAG task or scenario. Note that Cᵢ takes the form of a conversational chain with alternating User and Assistant turns representing QA pairs. The following descriptions of training tasks include a number of RAG tasks which may be employed in some embodiments for supervised fine-tuning.

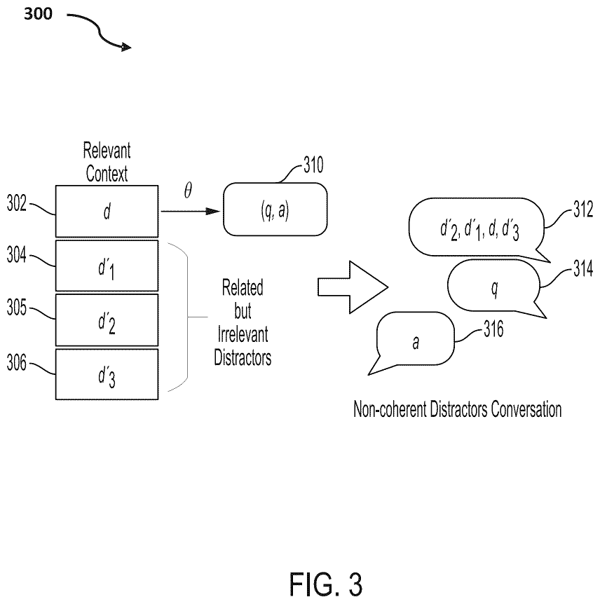

One task for training may include non-coherent distractors. RAG applications often feed the LLMs with multiple retrieved context passages, often only one of which is relevant and contains the answer while others being irrelevant and distracting. To build such data, a system obtains a text chunk d from D, then instructs the LLM θ to come up with a question q and answer a pair for the supposed relevant chunk d. After that, distractor chunks {d′₁, d′₂, . . . } are obtained by either randomly sampling them from D or using an external embedding model to retrieve chunks with close similarity with d from D. Finally, the system constructs a QA sample as (a|q, d, d′₁, d′₂, . . . ), where the order of chunks are randomized to prevent positional bias. An example of a method for generating non-coherent distractors is further described in FIG. 3.

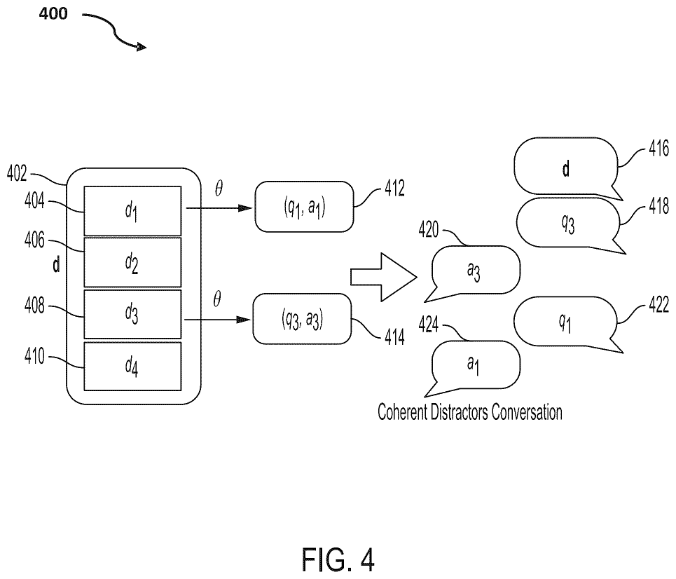

Another task for training may include coherent distractors, in which the context contains only one passage that is considerably long and coherent, such as an essay with multiple sections or a company's how-to knowledge article. In such cases, a question is often relevant only to one section or paragraph, while the remaining parts of the full text play as distractions. To construct a data sample of this kind, the system randomly samples a full document d within a pre-defined range of length (e.g., 4,000-8,000 tokens) from D. Then the system splits d into multiple formatted sections or paragraphs (d₁, d₂, d₃, . . . ). After that, the system prompts θ to produce (q, a) QA pair given a random d E (d₁, d₂, d₃, . . . ). Finally, the training data point is assembled as (a|q, d) as a coherent long context sample. An example of a method for generating non-coherent distractors is further described in FIG. 4.

Another task for training may include abstinence of unanswerables. An inevitable scenario of contextual QA is that the context does not contain the needed information to answer the question. The LLM needs to be familiar with such unanswerable conditions to refrain from hallucinating an incorrect answer. Such data is automatically generated by removing relevant context passages d from a standard contextual question answering pair (a|q, d), and then replacing them with irrelevant texts d′ and modifying the answer a into an abstinence response a′, such as “Sorry, I could not find the information in the provided context.”. The abstinence data sample takes the form of (a′|q, d′).

Another task for training may include extraction and citation. Providing citations is an important criteria for reliable and trustworthy RAG applications. In some embodiments, data of this type is generated by injecting citation information about the relevant context passages in the answer. The citations may be provided in different formats and styles. For example, a format for a response with citation can be “{answer} \n Citation: {document_index}-{document_content}”, where the {document_index} and {document_content} indicate where the answer is grounded on.

Another task for training may include diversification and format following. There are different ways to answer the same contextual question. Similar to coherent and non coherent distractors, the system prompts the LLM θ with unlabeled texts D to create QA pairs where the answers are generated with diversification in different forms, formats and styles. They can be short and direct answer, or long and elaborate answer. They may also contain extra explanation and complex reasoning to justify the final answer. The questions may also take other forms, such as open-ended, closed-book and multiple-choice questions. For these different cases, the system modifies the instruction to θ to fit each scenario and apply necessary post-processing step to the completed data samples to ensure that they are consistent with the formats and styles.

Another task for training may include summarization. LLMs have been shown to exhibit positional bias in contextual tasks where contents in the middle are often lost. This may be an issue for the summarization task where the context can be arbitrarily long, as the LLMs may miss out important information in the middle. To alleviate this problem, the system may generate synthetic summarization data via a hierarchical strategy. Specifically, first, given a long document d, the system may split the long document into multiple chunks and paragraphs (d₁, d₂, . . . ). Then, the system may use θ to produce summarizations sᵢ for each chunk dᵢ. This prevent the LLMs from skipping important details that potentially appear in the middle chunks. After that, the system prompts θ again to produce an overall summarization s given a concatenation of (s₁, s₂, . . . ). Finally, the system constructs the training data sample as (s|d).

Another task for training may include structured data. Beyond unstructured texts, RAG applications often involve different forms of structured data, such as tables, JSON or codes. Similar strategies as above may be employed on unlabeled sources of tabular and code data. For example, given a sufficiently large codebase d, a system may extract a small segment d about which the system prompts the LLM θ to create a question q and answer a. Then the system generates a training data point (a|q, d) where the entire codebase is the context information to introduce a higher degree of confusion and difficulty for the model.

Another task for training may include function calling. Agentic capabilities via function calling are intertwined with retrieval augmented generation. Specifically, LLMs may call functions or tools dynamically to query external data sources (e.g., knowledge graphs and relational databases) for contextual information, rewrite queries to be search-engine-optimized, perform calls search tools iteratively with reasoning in multi-hop question answering. To produce synthetic data, traditional contextual data (a|q, d) is transformed into function-calling variants by first introducing function definitions in the System prompt, with simple LLM-friendly names such as search_web or query_api. Then, the system prompts θ for it to come up with a short query \hat{q} given the question q. Finally, the system constructs the function-calling sample as a sequence of user question q (User turn), model's action to call a function with the query \hat{q} (e.g., search_web (query=q)) in the Thought turn, “returned” context document d in the Observation turn, and lastly the model's answer a in the Assistant turn.

In some embodiments, the training methods described herein result in an LLM not only good for contextual tasks but just as good at regular noncontextual assistant as any conventional LLMs. For this, the system may include considerable portions of general instruction following data in the fine-tuning mixture. The data is focused in various aspects, including multi-turn conversations, world knowledge inquiry, creative writing and math reasoning.

The instruction data with eligible task types, such as function calling and contextual tasks, are diversified in both traditional User-Assistant format and the User-Thought-Observation-Assistant format illustrated in FIG. 2 to ensure that the model is adaptable to different prompting styles and applications. For example, in the User-Assistant format, the contextual passages can be injected into the User or System turn. The system may ensure the instruction tuning data mixture in the conversational formats are balanced such that no single source of data dominates the entire mixture. During training, the system may select random samples into a single sequence up to the maximum context length and separate the attention masks so that attention does cross beyond sample boundary. In some embodiments, cross entropy loss (i.e., mask-in) is applied only to the Thought and Assistant turns of the data samples.

FIG. 3 is a simplified diagram of a non-coherent distractors training data generation method 300 according to some embodiments. To generate a non-coherent distractors conversation for training, a system obtains a text chunk d 302 from a corpus D which may include multiple documents. The system then instructs an LLM to come up with a question (q) and answer (a) pair 310 for the supposed relevant chunk d 302. After that, distractor chunks (e.g., d′₁ 304, d′₂ 305, d′₃ 306) are obtained by either randomly sampling them from a corpus D or using an external embedding model to retrieve chunks with close similarity with d from D. The system may then construct a QA sample as (a|q, d, d′₁, d′₂, . . . ), where the order of chunks may be randomized to prevent positional bias. In the illustrated example, the chunks are provided as retrieved data 312 in a randomized order, followed by the question 314 and answer 316. The example in FIG. 3 illustrates the chunks as being uttered by a user. In some embodiments, the chunks may be included as utterances from another role, for example and “observation” role representing retrieved data.

FIG. 4 is a simplified diagram of a coherent distractors training data generation method 400 according to some embodiments. To generate a coherent distractors conversation for training, the system randomly samples a full document d 402 within a pre-defined range of length (e.g., 4,000-8,000 tokens) from a corpus D. Then the system splits d 402 into multiple formatted sections or paragraphs (d₁ 404, d₂ 406, d₃ 408, d₄ 410 . . . ). After that, the system prompts an LLM to produce (q, a) QA pair 412 given a random d ε (d₁, d₂, d₃, . . . ), in the illustrated example it is based on dᵢ 404. In some embodiments, additional QA pairs may be generated using the same or different chunks from d 402. In the illustrated example this includes QA pair 414 which is based on d₃ 408. Finally, the training data point is assembled as (a|q, d) as a coherent long context sample. For example, as illustrated, the full document (or the portion of the document defined by the range) is provided. This may be provided as a user utterance, observation utterance, etc. The document is followed by one of the generated questions 418 and the associated answer 420. This is then followed by another generated question 422 and associated answer 424. In this way, it is known that the questions 418 and 422 are answerable given the utterance 416, however it is within a larger document such that the LLM being trained with this data needs to be capable of finding the relevant information within the larger document.

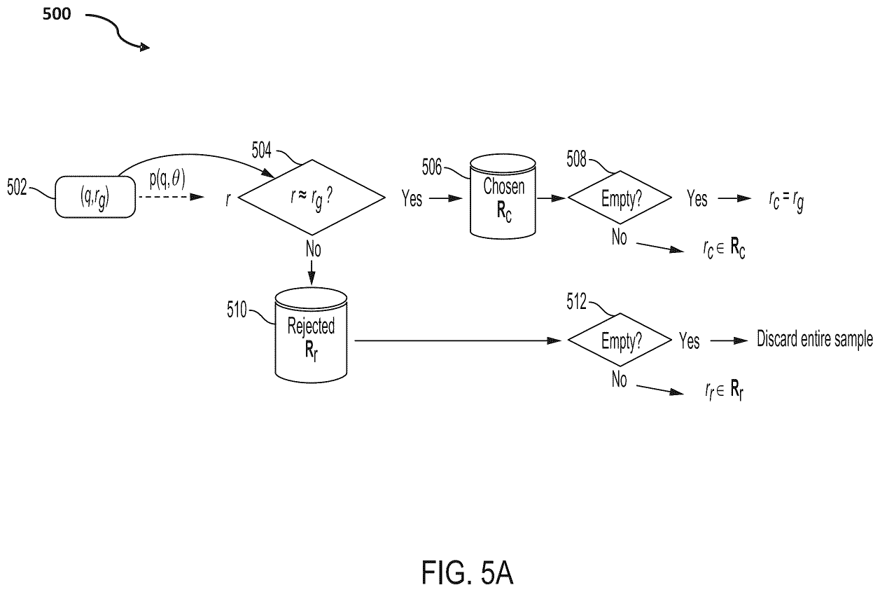

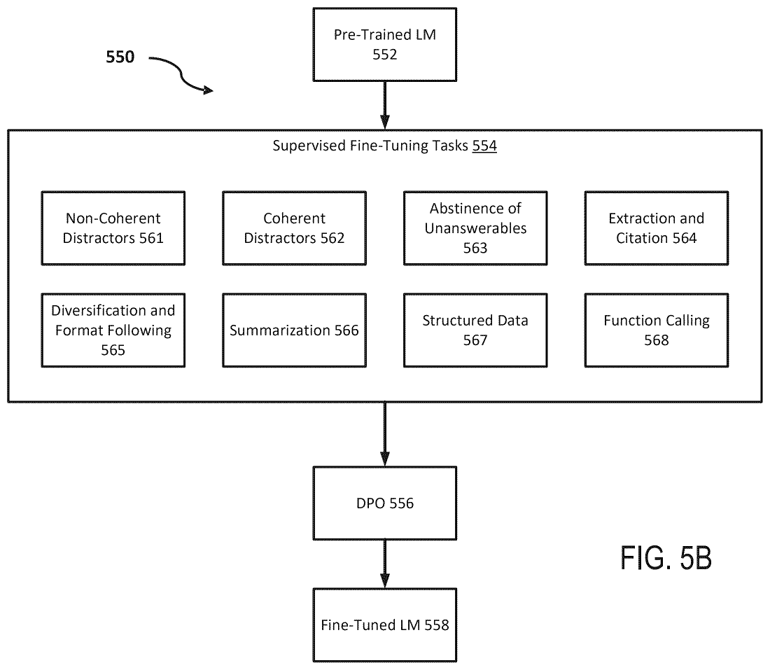

FIG. 5A is a simplified diagram of a preference optimization method 500 according to some embodiments. Preference learning may be used as a training step towards training aligned language models. In some embodiments this process trains the model to place more probability on responses with high rewards and penalize responses with lower rewards. Not only is this stage crucial for steering the model's behavior into one that is generally preferred in terms of quality, safety and style, it also plays a role in fixing any mistakes made by an instruction-tuned model.

In some embodiments, preference data is generated using a model-based approach, using effective prompting and post-processing strategies to reliably produce reward signals for the model's responses using the model itself as a judge. An initial training corpus may be provided including known-good query/response pairs. As illustrated, query/response pair 502 is one such example.

For a given query q in the training data, the model θ is prompted for responses r as:

$$r ∼ p ( \cdot \vert q ; θ ) \qquad ( 2 )$$

Then using a few-shot prompt instruction h_{fewshot} to prompt the model again to determine, as a boolean decision o_{binary}, if the response r aligns with the corresponding ground truth label r_{g}:

$${o}_{binary} ∼ p ( \cdot \vert r , {r}_{g} , q , {h}_{fewshot} ; θ ) \qquad ( 3 )$$

where o_{binary}=1 if r aligns with r_{g}, otherwise o_{binary}=0.

As LLMs may not always produce answer in a fixed format, the few-shot prompt h_{fewshot} is written to instruct the model to be more lenient to format variations rather than strict matching. In other words, “Paris” and “The answer is Paris.” Are considered equivalent and aligned. This is represented as decision 504 which determines if a generated response r is sufficiently close to the ground-truth response r_{g}. Alternative methods may be utilized for determining if it is similar enough. For example, based on a strict exact match, a semantic similarity, etc. In general, the similarity of r and r_{g} is quantified as a similarity metric value (based on the metric such as LLM comparison, semantic similarity etc.), and if the similarity metric value is above some predetermined threshold then it is considered sufficiently similar. After this reward rating stage, inaccurate responses (o_{binary}=0) are selected as rejected responses rᵣ 510, while accurate responses with o_{binary}=1 (or the ground truth response if the model fails to produce an accurate one after a few attempts) are considered as chosen responses r_{c} 506 for preference fine-tuning.

Some open-ended general instructions do not always convey a definitive correct answer, such as an instruction to write an email. For such data, we use an additive scoring LLM-as-judge method may be used by prompting the model to produce scores o_{reward} along with its own reasoning multiple times, and ensemble the ratings via majority voting to improve consistency. As the model may not be as strong and knowledgeable to play as a reliable judge, the ground-truth response r_{g} may also be added to the rewarding prompt h_{reward} so that r_{g} serves as an reference gold response. In other words, while a highly rewarded response r may not be identical to the gold response r_{g}, it should resemble the quality, accuracy and style of the gold response. More formally, the reward scores may be defined as:

$${o}_{reward} ∼ p ( \cdot \vert r , {r}_{g} , q , {h}_{reward} ; θ ) \qquad ( 4 )$$

where o_{reward}∈{1, . . . 5} with 5 being the highest reward. In some embodiments, multiple responses r are sampled and collect their corresponding reward o_{reward}. Then, the rejected response rᵣ are selected to be the lowest-reward response if its score o_{reward}≤o_{rejected-max}, where o_{rejected-max} is the upper bound for a rejected response. That is, if the lowest-reward response has a reasonably high reward score, it is not considered to be an unfavorable response to be penalized by the training objective.

Similarly, a chosen response r_{c} may be selected to be the highest-reward response if its score o_{reward}≥o_{chosen-min} with o_{chosen-min} being the lower bound for a chosen response. For preference data filtering, if none of the generated responses satisfies the rejected upper bound o_{rejected-max}, the entire sample instance with question q is discarded from the training preference data because the sample is considered to be too easy for the model. As illustrated, at decision 512, if the set of rejected responses 510 is empty, then the sample is discarded for training (including the query and chosen responses 506). In the case where there is one or more responses in rejected responses 510, then those samples are used as negative samples for training. Meanwhile, if none of the generated responses satisfies the chosen lower bound o_{chosen-min}, the ground truth response r_{g} plays as the chosen response r_{c}, assuming that the sample question q is too difficult for the policy model to respond satisfactorily. As illustrated, if the chosen responses 506 is empty at decision 508, then the ground-truth response may be used as the positive sample for training. If the chosen responses 506 is not empty at decision 508, then the those chosen responses 506 may be used as positive samples in training.

Certain use cases require accurately and consistently following a format, such as responding with citations of a particular format, bullet point format, or stating outputs with JSON, Latex or Markdown format. For training data requiring a specific format, the similarity metric may include a deterministic parsing of the responses to determine if that meet the strict formatting requirements. If the response is parsed successfully, it will be selected as chosen response r_{c}, otherwise it will be considered as rejected response rᵣ. This may be in place of or in addition to other similarity metrics. If none of the responses is parsed successfully, the newly transformed ground-truth response is denoted as r_{c}. Conversely, if all responses comply with the format, the entire data instance is filtered out from the preference data mixture.

A modified version of direct preference optimization (DPO) may be used to conduct preference tuning for the model using the conversational preference data synthesized from the strategies explained above. Particularly, in addition to the DPO loss (e.g., as described in Rafailov et al., Direct Preference Optimization: Your Language Model is Secretly a Reward Model, arXiv:2305.18290, 2023), a cross-entropy loss of the chosen response r_{c} may be used as a regularization term to prevent excessive model distribution shift from a reference model. In some embodiments, at a probability (e.g., 50%), end-of-turn tokens of the rejected response may be dropped when computing the DPO loss, which prevents over-penalizing this token and alleviates an issue where the model fails to stop with the end-of-turn token after finishing a generation. In some embodiments, losses are only applied on the Assistant turns and Thought turns (if they exist) of the conversation. To prevent overfitting on non-contributing parts of the data sample, however, loss components may be removed on turns where the contents of chosen and rejected conversations are identical, which may lead to zero DPO loss and numerical instability.

FIG. 5B is a simplified diagram illustrating a language model training framework 550 according to some embodiments. The framework 550 comprises an input pre-trained language model 552. Pre-trained language model 552 is fine-tuned via one or more supervised fine-tuning tasks 554. Training using these tasks may be performed in sequence, interleaved, or in any combination. Training and/or data generation for each of the tasks may be generated as described in FIG. 2. Supervised fine-tuning tasks 554 may include tasks such as non-coherent distractors 561, coherent distractors 562, abstinence of unanswerables 563, extraction and citation 564, diversification and format following 565, summarization 566, structured data 567, and/or function calling 568 as described in FIG. 2.

In some embodiments, an additional modified direct preference optimization 556 as described in FIG. 5A is performed on the language model after supervised fine-tuning 554. In some embodiments, DPO 556 is performed without supervised fine-tuning 554. The result of supervised fine-tuning tasks 554 and/or direct preference optimization 556 is a fine-tuned language model 558. The fine-tuned language model 558 may be used in providing a chat interface to a user which may provide responses to queries, including responses that require the language model to retrieve relevant contexts to respond accurately. Fine-tuned language model 558 may be included in a system that allows for retrieval of contexts based on queries generated by fine-tuned language model 558, and the retrieved contexts may be used by fined-tuned language model 558 to generate a response to a user query. In some embodiments, the chat template utilized by fine-tuned language model 558 and/or pre-trained language model 552 includes a “system” turn, a “user” turn, one or more “thought” turns, one or more “observation” turns, and an “assistant” turn. Training using this chat structure may include training “thought” and “assistant” turns while masking out the other turns (e.g., wherein those turns are inputs provided by the training data in the training process).

### Computer and Network Environment

FIG. 6A is a simplified diagram illustrating a computing device 600 implementing the language model training framework described in FIGS. 1-5B, according to one embodiment described herein. As shown in FIG. 6A, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In another embodiment, processor 610 may comprise multiple microprocessors and/or memory 620 may comprise multiple registers and/or other memory elements such that processor 610 and/or memory 620 may be arranged in the form of a hardware-based neural network, as further described in FIG. 6B.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for LM training module 630 that may be used to implement and/or emulate the systems and models, and/or to implement any of the methods described further herein. LM training module 630 may receive input 640 such as an input training data (e.g., query and response pairs, chat logs, chats including thoughts and observations etc.) via the data interface 615 and generate an output 650 which may be a fine-tuned language model and/or responses to user queries.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as a query, from a user via the user interface.

In some embodiments, the LM training module 630 is configured to train and/or fine-tune a language model, and/or perform inference using the fine-tuned model as described in FIGS. 1-5B. The LM training module 630 may further include data generation submodule 631 configured to generate training data as described in FIGS. 1-5B and elsewhere herein. The LM training module 630 may further include training submodule 632 configured to train and/or fine-tune a language model as described in FIGS. 1-5B and elsewhere herein.

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6B is a simplified diagram illustrating the neural network structure implementing the LM training module 630 described in FIG. 6A, according to some embodiments. In some embodiments, the LM training module 630 and/or one or more of its submodules 631-632 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as a query. The number of nodes (neurons) in the input layer 641 may be determined by the dimensionality of the input data (e.g., the length of a vector of the query). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6A, the LM training module 630 receives an input 640 of a query and transforms the input into an output 650 of a response. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LM training module 630 and/or one or more of its submodules 631-632 may comprise the transformative neural network structure of layers of neurons, and weights and activation functions describing the non-linear transformation at each neuron. Such a neural network structure is often implemented on one or more hardware processors 610, such as a graphics processing unit (GPU).

In one embodiment, the LM training module 630 and its submodules 631-632 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110) may receive a natural language input (such as a question) and generate a natural language output (such as an answer to the question).

In one embodiment, the LM training module 630 and its submodules 631-632 may be implemented by hardware, software and/or a combination thereof. For example, the LM training module 630 and its submodules 631-632 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the LM training module 630 and its submodules 631-632 and/or any other neural network models such as fine-tuned LM 558 described in FIG. 5B onto hardware platform 660, the neural network based modules 630 and its submodules 631-632 may be optimized for deployment by converting it to a suitable format, such as ONNX or TensorRT, to improve performance and compatibility. Next, depending on the size and workload requirements for modules 630 and its submodules 631-632, hardware types may be chosen for deployment, e.g., processing capacity, GPU memory size, and/or the like. Frameworks and drivers for the chosen hardware 660 frameworks and drivers may thus be installed, such as PyTorch, TensorFlow, or CUDA, to support the hardware platform 660. Then, weights and parameters of the LM training module 630 and its submodules 631-632 may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the LM training module 630 and its submodules 631-632 may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the LM training module 630 and its submodules 631-632 may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LM training module 630 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LM training module 630 and one or more of its submodules 631-632 may be trained by iteratively updating the underlying parameters (e.g., weights 651, 652, etc., bias parameters and/or coefficients in the activation functions 661, 662 associated with neurons) of the neural network based on the loss. For example, during forward propagation, the training data such as multi-turn chats are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding ground-truth response) from the training data, to compute a loss function that measures the discrepancy between the predicted output and the expected output. For example, the loss function may be a DPO loss and/or a cross-entropy loss. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based LM training module 630 and one or more of its submodules 631-632 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

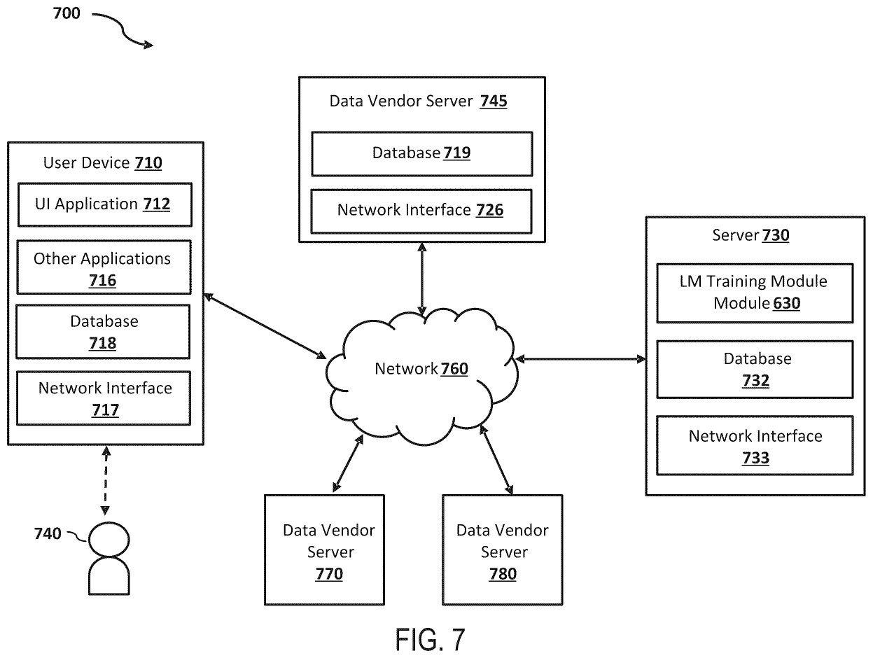

In some embodiments, LM training module 630 and its submodules 631-632 may be housed at a centralized server (e.g., computing device 600) or one or more distributed servers. For example, one or more of LM training module 630 and its submodules 631-632 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen queries.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in language model training.

FIG. 7 is a simplified block diagram of a networked system 700 suitable for implementing the language model training framework described in FIGS. 1-6B and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 600 described in FIG. 6A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating a response from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the LM training module 630 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which LM training module 630 may generate a response via the process described in FIGS. 1-6B. The LM training module 630 may thus cause a display of a response at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view responses.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including queries, responses, multi-turn chats etc. to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the LM training module 630 and its submodules described in FIG. 6A. In some implementations, LM training module 630 may receive data from database 719 at the data vendor server 745 via the network 760 to generate responses. The generated responses may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the LM training module 630. In one implementation, the database 732 may store previously generated responses, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

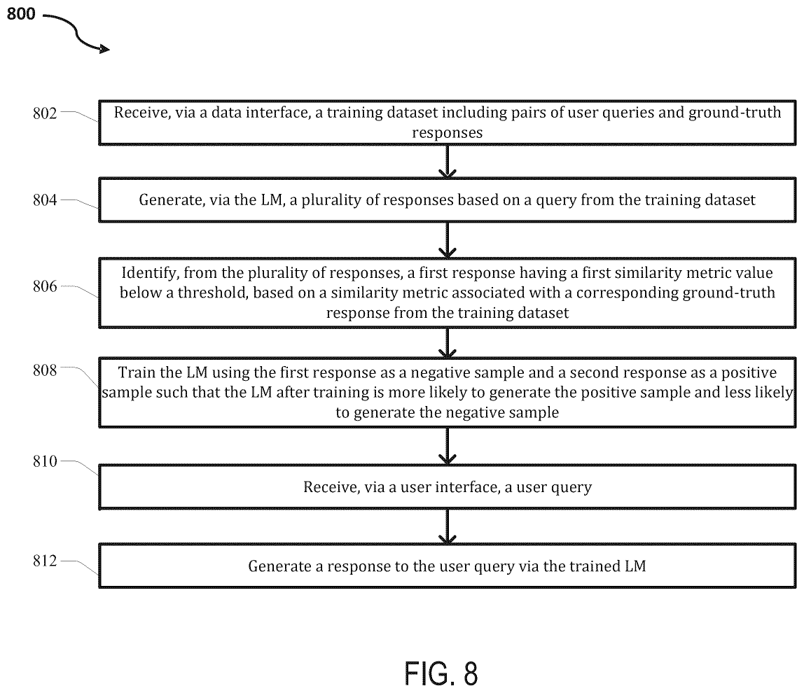

FIG. 8 is an example logic flow diagram illustrating a method of training a neural network based language model based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the LM training module 630 (e.g., FIGS. 6A and 7) that performs language model training and inference as described herein.

In some embodiments, method 800 is performed by a system such as computing device 600, user device 710, server 730, or another device or combination of devices. Inputs (e.g., a user query) may be received via a data interface such as data interface 615, network interface 717, network interface 733, or via a data interface that is integrated with a device. For example UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, a system receives, via a data interface, a training dataset including pairs of user queries and ground-truth responses.

At step 804, the system generates, via the LM, a plurality of responses based on a query from the training dataset (e.g., the query from training data 502).

At step 806, the system identifies, from the plurality of responses, a first response (e.g., a rejected response 510) having a first similarity metric value below a threshold, based on a similarity metric associated with a corresponding ground-truth response from the training dataset. In some embodiments, the first similarity metric value is generated by a second LM based on a prompt including the first response and the corresponding ground-truth response. In some embodiments, the prompt further includes the query and a request that a response that does not follow a format specified by the query receive a lower score In some embodiments, the corresponding ground-truth response from the training dataset includes a plurality of turns of a chat, wherein the plurality of turns include text from roles including a system role, a user role, a thought role, an observation role, and an assistant role. The system role may represent a system prompt describing a desired behavior of the assistant role. The user role may represent a human user interacting with the assistant role. The thought role may represent an intermediate generation by the LM not presented to the human user. The observation role may represent retrieved information not presented to the human user. The assistant role may represent a response provided to the human user.

At step 808, the system trains the LM using the first response as a negative sample and a second response as a positive sample such that the LM after training is more likely to generate the positive sample and less likely to generate the negative sample. In some embodiments, the system identifies, from the plurality of responses, the second response (e.g., a chosen response 506) having a second similarity metric value above the threshold, based on the similarity metric. In some embodiments, training the LM is performed using the corresponding ground-truth response as the second response based on each of the plurality of responses having a corresponding similarity metric value below the threshold. In some embodiments, the system further trains the LM via a supervised fine-tuning task including a second training dataset including at least one of: non-coherent distractors, coherent distractors, abstinence of unanswerables, extraction and citation, diversification and format following, summarization, structured data, or function calling.

In some embodiments, the non-coherent distractors include a second query, a known-good document including information relevant to answering the second query, and a plurality of documents retrieved from a database that are related to the second query but do not contain information relevant to answering the second query. In some embodiments, the coherent distractors include a second query and a plurality of documents retrieved from a database including information relevant to answering the second query in addition to irrelevant information within the same documents.

At step 810, the system receives, via a user interface (e.g., UI application 12), a user query (e.g., user query 106).

At step 812, the system generates a response (e.g., response 108) to the user query via the trained LM.

In some embodiments, the system generates, via the LM, a second plurality of responses based on a second query from the training dataset. Training the LM may be performed without any of the second plurality of responses nor a second corresponding ground-truth response associated with the second query, based on each of the second plurality of responses having a corresponding similarity metric value above the threshold, based on the similarity metric associated with the second corresponding ground-truth response.

In some embodiments, method 800 is applicable in a variety of applications. For example, the task request received by a neural network model (e.g., LM 558) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 800, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

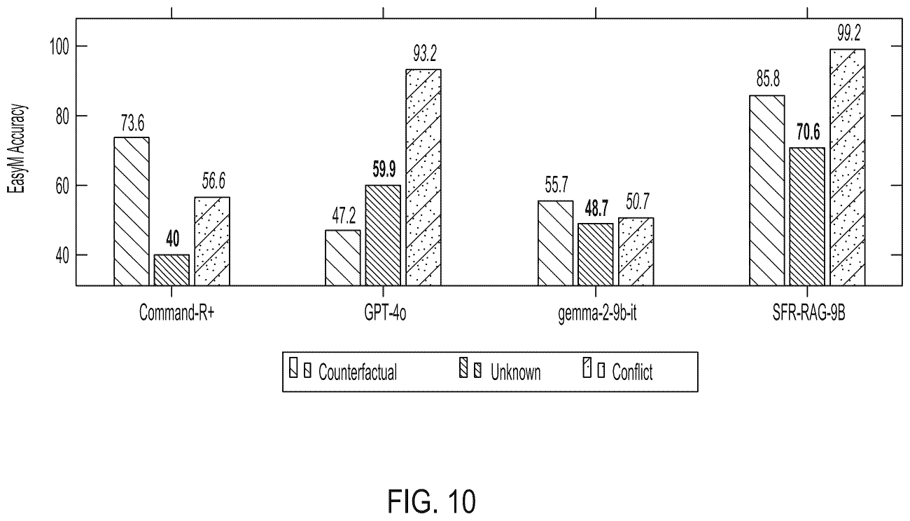

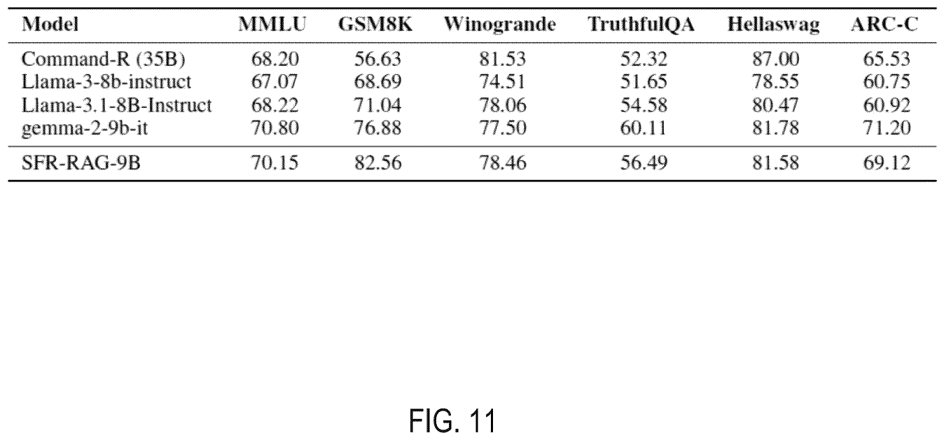

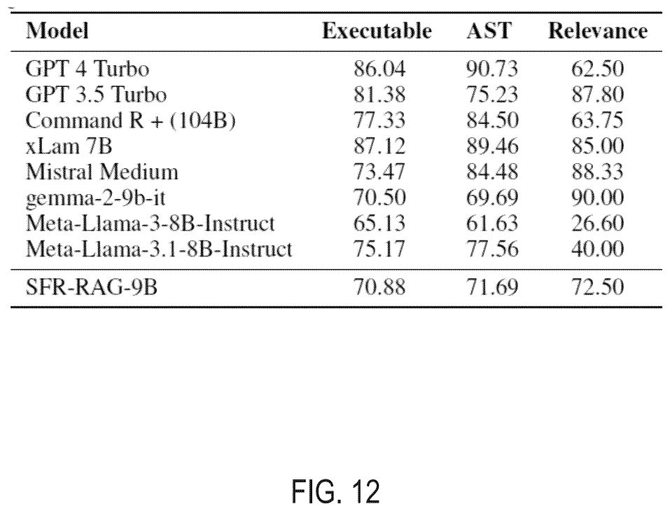

FIGS. 9-12 represent exemplary test results using embodiments described herein. The model trained using embodiments of methods described herein is referred to in the experimental results as SFR-RAG. FIG. 9 shows Performances of the model and various open- and closed-source baselines across 7 contextual question answering tasks in ContextualBench. Bold numbers mean best of all, while underlined numbers mean best among open-source models. PopQA is measured in easy-match accuracy (EasyEM), while the rest are measured in exact-match accuracy (EM). FIG. 10 shows FaithEval: average easy match accuracy scores of different models when contextual facts are altered and fabricated (Counterfactual), removed (Unknown) or when the facts are contradicting (Conflict). Small variations between those settings and overall high absolute scores indicate that the model is resilient to changes in contextual information. FIG. 11 shows Standard LM-eval-harness benchmarks: the model maintains relative competitiveness in standard world knowledge and reasoning abilities against comparable baselines. FIG. 12 shows Scores on Berkeley function calling benchmark. The model exhibits competitive function calling Scores on Berkeley function calling benchmark (as in Yan et al., Berkeley function calling leaderboard. 2024). The model exhibits competitive function.

There are already several evaluation protocols available to measure performance of LLMs and RAG systems on contextual understanding across different domains and complexities. However, prior studies have reported results on non-overlapping measures, datasets and inconsistent setups, especially on which contextual content to present to the LLMs and model hyper-parameters. This causes challenges in directly comparing results from different studies.

Contextual Bench is primarily an aggregation of 7 popular contextual question answering texts, namely HotpotQA (Yang et al., HotpotQA: A dataset for diverse, explainable multi-hop question answering. In Conference on Empirical Methods in Natural Language Processing (EMNLP), 2018); TriviaQA (Joshi et al., Triviaqa: A large scale distantly supervised challenge dataset for reading comprehension. arXiv preprint arXiv:1705.03551, 2017); TruthfulQA (Lin et al., Truthfulqa: Measuring how models mimic human falsehoods. arXiv preprint arXiv:2109.07958, 2021); PopQA (Mallen et al., When not to trust language models: Investigating effectiveness of parametric and non-parametric memories. arXiv preprint arXiv:2212.10511, 2022); 2WikiHopQA (Ho et al., Constructing a multi-hop QA dataset for comprehensive evaluation of reasoning steps. In Scott et al., eds., Proceedings of the 28th International Conference on Computational Linguistics, pages 6609-6625, Barcelona, Spain (Online), December 2020. International Committee on Computational Linguistics. doi: 10.18653/v1/2020.coling-main.580. URL https://aclanthology.org/2020.coling-main.580) Musique (Trivedi et al., Musique: Multihop questions via single-hop question composition. Transactions of the Association for Computational Linguistics, 10:539-554, 2022) and Natural Questions (NQ) (Kwiatkowski et al., Natural questions: a benchmark for question answering research. Transactions of the Association for Computational Linguistics, 7:453-466, 2019).

There are a few key contributions that make ContextualBench stand out as a comprehensive benchmarking framework for contextual LLMs. The measures in ContextualBench are evaluated under the same instruction with contextual contents being consistently specified. The contextual contents include the original context documents of each benchmark if provided, or otherwise they are retrieved from a much larger Wikipedia database with an embedding model of choice. As it is not trivial to evaluate assistant-style LLMs with a wide range of verbosity in the generated output, ContextualBench offers multiple scoring methods to account for variations in answers compared to the ground truths. These scoring methods are (i) Exact Match (EM) of the generated answer with the ground truth, (ii) Easy match (EasyM) to check if the ground truth is in the generated answer, and (iii) the F1 score, with room for further addition. ContextualBench offers multiple setups common in the RAG scenarios, among which is whether to retrieve top-k chunks using consistent embedding models or feed the entire available contextual documents directly to the LLM (no retrieval needed). The variety of measures and tasks in ContextualBench enables both holistic and specific evaluation of contextual LLMs. By weighing each task and measure equally, ContextualBench allows for direct comparison of model performance in general. On the other hand, depending on practitioner use-case and domain specifications, certain measures or datasets may be prioritized, allowing for quick identification of the best task-specific models.

For 2WikiHopQA, HotpotQA and Musique, the context documents are already provided for each question, they can be used directly as contextual sources. For TriviaQA, TruthfulQA, and NQ, the questions come with their respective Wikipedia article or source URL. Content was scraped from these sources and Cohere embedding was used to retrieve top-10 chunks from the contextual sources where each chunk is 512 tokens long. Meanwhile, PopQA itself does not come with context documents, so off-the-shelf context documents were produced by the Self-RAG retriever (Asai et al., 2023). For each task, the test set is tested to see they are complete with gold labels, otherwise the entire validation set is used to measure models' performance. This is different from the Cohere Team's Command-R's report where HotpotQA evaluation was conducted on a 100-sample subset of validation set, with no details about the context documents disclosed. ContextualBench contains popular existing benchmarks, such as TriviaQA and TruthfulQA, where evaluation utilizes certain contexts to which models are expected to be faithful. That is, models are expected to utilize only the information found in such contexts, in contrast to traditional closed-book QA settings, where the parametric knowledge of LLMs are evaluated sans provided contexts.

FIG. 9 illustrates a experimental results of the model (referred to in all figures as 9B SFR-RAG) on ContextualBench compared against state-of-the-art large models as well as comparable ones across the 7 question answering tasks. PopQA scores are measured in easy matching, while the remaining are measured in exact matching. As shown, GPT-40 (OpenAI. Gpt-4 technical report. arXiv preprint, 2023) unsurprisingly aces most of the benchmarks. However, given its small size, the present model significantly outperforms strong open-source baselines such as Command-R and Command-R+ that have up to 10 times larger parameter counts. Remarkably, it achieves the state of the art in TruthfulQA, 2WikihopQA and HotpotQA in contextual settings. Overall, it also achieves the state of the art average performance, demonstrating the model's strong ability across many contextual tasks. In particular, the model excels at 2WikiHotPotQA, with nearly a 25% increase in performance compared to GPT-40. Meanwhile, the model consistently outperforms Llama-3.1 8B Instruct (Dubey et al., The llama 3 herd of models. arXiv preprint arXiv:2407.21783, 2024), and gemma-2-9b-it (Gemma Team, Gemma: Open models based on gemini research and technology. arXiv preprint arXiv:2403.08295, 2024), across most benchmarks.

Because most QA benchmarks are realistically based on real-world facts, understanding LLMs performance in contextual QA tasks may be ambiguous because high scores may be attributed to either (i) the ability to seek accurate facts from the contextual documents and content, or (ii) the intrinsic parametric knowledge of the model acquired during pre-training, of which large and state-of-the-art models like GPT-40 often have significant advantages.

FaithEval is an evaluation suite that measures how LLMs remain faithful to the context if the facts of the contexts are changed. The benchmark evaluates LLMs on three scenarios: (i) “Unknown” where the relevant facts are removed, and the original question becomes unanswerable; (ii) “Conflict” where multiple context documents are provided that contains conflicting or contradicting information and the model is expected to recognize that; and (iii) “Counterfactual” where certain commonsense facts are altered by introducing a falsely fabricated context document. For instance, “The Moon is Made of Marshmallows” is considered a counterfactual context and the LLM under evaluation is expected to remain faithful to that “fact”, if prompted to do so. Following Ming et al. the “Unknown” and “Conflict” tasks are averaged over 10 benchmarks while the “Counterfactual” task is evaluated using the ARC-C dataset.

FIG. 10 shows the average non-strict matching accuracy scores of different LLMs over 3 tasks under FaithEval suite. As shown, while other baselines such as GPT-40 exhibit high variations when the facts change in Counterfactual and Unknown settings, the present model scores consistently highly, even when the context information is altered. This demonstrates that the model is usefully resilient and faithful to unseen contextual information. The model is also more capable of identifying contradiction in the contexts, as well as resisting against its own parametric knowledge when contextual information presented is counterintuitive. In other words, the model remains more faithful to the context even if the context contradicts its pre-trained knowledge.

The present model was also tested in the traditional few-shot prompting benchmarks (Dua et al., Drop: A reading comprehension benchmark requiring discrete reasoning over paragraphs. arXiv preprint arXiv:1903.00161, 2019; Hendrycks et al., Measuring massive multitask language understanding. Proceedings of the International Conference on Learning Representations (ICLR), 2021), to measure its parametric knowledge as well as general instruction following and reasoning abilities. Using the similar setups in the Open LLM leaderboard (Beeching et al., Open Ilm leaderboard, 2020). The standard evaluation harness (Gao et al., A framework for few-shot language model evaluation, 07 2024.) was employed to evaluate the model in MMLU (5 shots) (Hendrycks et al., 2021); GSM8K (5 shots with strict matching) (Cobbe et al., Training verifiers to solve math word problems. arXiv preprint arXiv:2110.14168, 2021); Winogrande (5 shots) (Sakaguchi et al., Winogrande: An adversarial winograd schema challenge at scale. Communications of the ACM, 64 (9): 99-106, 2021); TruthfulQA (0 shot MC2) (Lin et al., 2021), Hellaswag (10 shots with normalized accuracy) (Zeller et al., Hellaswag: Can a machine really finish your sentence? arXiv preprint arXiv:1905.07830, 2019); and ARC-C (25 shots with normalized accuracy) (Clark et al., Think you have solved question answering? try arc, the ai2 reasoning challenge. arXiv preprint arXiv:1803.05457, 2018).

FIG. 11 illustrates how the present model performs competitively in terms of world knowledge, common sense and reasoning abilities, despite the fact that it is optimized for contextual and retrieval use cases. Particularly, the model outperforms Command-R with 35B parameters in MMLU, GSM8K, TruthfulQA as well as ARC-C. Meanwhile it remains competitive to gemma-2-9b-it, which shares the same base pre-trained model. The model is also trained with function calling with a focus to support dynamic and multi-hop interactions with external tools to retrieve high-quality contextual information. Therefore, the model can be compared with certain popular baselines in the Berkeley function calling task.

FIG. 12 illustrates that the model performs competitively against comparable baselines such as Llama-3-8B-Instruct.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a neural network based language model (LM), comprising:
receiving, via a data interface, a training dataset including pairs of user queries and ground-truth responses;
generating, via the LM, a plurality of responses based on a query from the training dataset;
identifying, from the plurality of responses, a first response having a first similarity metric value below a threshold, based on a similarity metric associated with a corresponding ground-truth response from the training dataset;
training the LM using the first response as a negative sample and a second response as a positive sample such that the LM after training is more likely to generate the positive sample and less likely to generate the negative sample;
receiving, via a user interface, a user query; and
generating a response to the user query via the trained LM.

2. The method of claim 1, further comprising:
identifying, from the plurality of responses, the second response having a second similarity metric value above the threshold, based on the similarity metric.

3. The method of claim 1, wherein the training the LM is performed using the corresponding ground-truth response as the second response based on each of the plurality of responses having a corresponding similarity metric value below the threshold.

4. The method of claim 1, further comprising:
generating, via the LM, a second plurality of responses based on a second query from the training dataset,
wherein training the LM is performed without any of the second plurality of responses nor a second corresponding ground-truth response associated with the second query, based on each of the second plurality of responses having a corresponding similarity metric value above the threshold, based on the similarity metric associated with the second corresponding ground-truth response.

5. The method of claim 1, wherein the first similarity metric value is generated by a second LM based on a prompt including the first response and the corresponding ground-truth response.

6. The method of claim 5, wherein the prompt further includes the query and a request that a response that does not follow a format specified by the query receive a lower score.

7. The method of claim 1, wherein the corresponding ground-truth response from the training dataset includes a plurality of turns of a chat, wherein the plurality of turns include text from roles including a system role, a user role, a thought role, an observation role, and an assistant role, and wherein:
the system role represents a system prompt describing a desired behavior of the assistant role,
the user role represents a human user interacting with the assistant role,
the thought role represents an intermediate generation by the LM not presented to the human user,
the observation role represents retrieved information not presented to the human user, and
the assistant role represents a response provided to the human user.

8. The method of claim 1, further comprising:
training the LM via a supervised fine-tuning task including a second training dataset including at least one of: non-coherent distractors, coherent distractors, abstinence of unanswerables, extraction and citation, diversification and format following, summarization, structured data, or function calling.

9. The method of claim 8, wherein the non-coherent distractors include:
a second query;
a known-good document including information relevant to answering the second query; and
a plurality of documents retrieved from a database that are related to the second query but do not contain information relevant to answering the second query.

10. The method of claim 8, wherein the coherent distractors include:
a second query; and
a plurality of documents retrieved from a database including information relevant to answering the second query in addition to irrelevant information within the same documents.

11. A system for training a neural network based language model (LM), the system comprising:
a memory that stores the LM and a plurality of processor executable instructions;
a communication interface that receives a training dataset including pairs of user queries and ground-truth response; and
one or more hardware processors that read and execute the plurality of processor-executable instructions from the memory to perform operations comprising:
generating, via the LM, a plurality of responses based on a query from the training dataset;
identifying, from the plurality of responses, a first response having a first similarity metric value below a threshold, based on a similarity metric associated with a corresponding ground-truth response from the training dataset;
training the LM using the first response as a negative sample and a second response as a positive sample such that the LM after training is more likely to generate the positive sample and less likely to generate the negative sample;
receiving, via a user interface, a user query; and
generating a response to the user query via the trained LM.

12. The system of claim 11, further comprising:
identifying, from the plurality of responses, the second response having a second similarity metric value above the threshold, based on the similarity metric.

13. The system of claim 11, wherein the training the LM is performed using the corresponding ground-truth response as the second response based on each of the plurality of responses having a corresponding similarity metric value below the threshold.

14. The system of claim 11, further comprising:
generating, via the LM, a second plurality of responses based on a second query from the training dataset,
wherein training the LM is performed without any of the second plurality of responses nor a second corresponding ground-truth response associated with the second query, based on each of the second plurality of responses having a corresponding similarity metric value above the threshold, based on the similarity metric associated with the second corresponding ground-truth response.

15. The system of claim 11, wherein the first similarity metric value is generated by a second LM based on a prompt including the first response and the corresponding ground-truth response.

16. The system of claim 15, wherein the prompt further includes the query and a request that a response that does not follow a format specified by the query receive a lower score.

17. The system of claim 11, wherein the corresponding ground-truth response from the training dataset includes a plurality of turns of a chat, wherein the plurality of turns include text from roles including a system role, a user role, a thought role, an observation role, and an assistant role, and wherein:
the system role represents a system prompt describing a desired behavior of the assistant role,
the user role represents a human user interacting with the assistant role,
the thought role represents an intermediate generation by the LM not presented to the human user,
the observation role represents retrieved information not presented to the human user, and
the assistant role represents a response provided to the human user.

18. The system of claim 11, further comprising:
training the LM via a supervised fine-tuning task including a second training dataset including at least one of: non-coherent distractors, coherent distractors, abstinence of unanswerables, extraction and citation, diversification and format following, summarization, structured data, or function calling.

19. The system of claim 18, wherein the non-coherent distractors include:
a second query;
a known-good document including information relevant to answering the second query; and
a plurality of documents retrieved from a database that are related to the second query but do not contain information relevant to answering the second query.

20. The system of claim 18, wherein the coherent distractors include:
a second query; and
a plurality of documents retrieved from a database including information relevant to answering the second query in addition to irrelevant information within the same documents.
